(19) United States
(12) Patent Application Publication
(10) Pub. No.: US 2008/0061922 A1
(43) Pub. Date: Mar. 13, 2008

(54) HIGH FREQUENCY CIRCUIT APPARATUS

(75) Inventors: KIYOTO NAKAMURA, TOKYO (JP); MASAZUMI YASUOKA, TOKYO (JP); HIROKAZU SANPEI, TOKYO (JP); YOSHIAKI MORO, TOKYO (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANTEST CORPORATION, TOKYO (JP)

(21) Appl. No.: 11/687,664

(22) Filed: Mar. 18, 2007

Related U.S. Application Data
(63) Continuation of application No. PCT/JP05/17014, filed on Sep. 15, 2005.

(30) Foreign Application Priority Data
Sep. 22, 2004 (JP) 2004-275088

(51) Int. Cl. H01H 37/00; H01H 1/00; H01H 11/00

(52) U.S. Cl. 337/298; 200/502; 29/622

(57) ABSTRACT

A microswitch that switches a signal path of a high-frequency signal is provided. The microswitch includes a circuit board; a pair of first feedthrough lines spaced from each other on a circuit board that electrically connect the first surface and the second surface of the circuit board, respectively; a pair of first signal lines which are faced to each other with a gap therebetween on a straight line connecting the pair of first feedthrough lines on the first surface of the circuit board and electrically connected to the pair of first feedthrough lines, respectively; and a movable section which can switch between being in contact with and being spaced from the first surface of the circuit board and electrically connects the pair of signal lines with each other when the it is in contact with the first surface of the circuit board.

### CROSS REFERENCE TO RELATED APPLICATION

This is a continuation application of PCT/JP2005/17014 filed on Sep. 15, 2005 which claims priority from a Japanese Patent Application(s) NO. 2004-275088 filed on Sep. 22, 2004, the contents of which are incorporated herein by reference.

### FIELD OF THE INVENTION

The present invention relates to a high-frequency circuit apparatus. Particularly, the present invention relates to a high-frequency circuit for a signal with a high-frequency equal to or higher than GHz.

### RELATED ART

Generally, as an example of high frequency circuit apparatus for high-frequency signals equal to or higher than GHz, various switching devices manufactured by MEMS technology has been proposed. Among them, a contact relay that switches a RF signal by driving a movable contact by electrostatic attraction proposed as, for example, in a non-patent document “MWE2003 Microwave Workshop Digest pp. 375-378”.

However, the conventional contact relay has had a problem that it can not be used for switching a high-frequency signal required for such as a semiconductor test apparatus. Additionally, a glass substrate is used for a switching device by the MEMS technology in general. However, when the glass substrate is bored with a drill in order to provide a feedthrough line penetrating through the glass substrate, the hole diameter is about 300 μm, so that each diameter of the high frequency signal line and the feedthrough line is approximately the same as that. Here, an electromagnetic wave is radiated from a portion at which the feedthrough line and the signal path are coupled to each other. Therefore, particularly in the case that a coplanar line is employed, the ground collects the electromagnetic wave from the coupling portion when the distance between the feedthrough line and the ground is reduced, so that the power of the signal is reduced.

### SUMMARY

Thus, the advantage of the present invention is to provide a high-frequency circuit apparatus which is capable of solving the problem accompanying the conventional art. The above and other advantages can be achieved by combining the features recited in independent claims. Then, dependent claims define further effective specific example of the present invention.

In order to solve the above described problems, a first aspect of the present invention provides a high-frequency circuit apparatus. The high-frequency circuit apparatus includes: a pair of first feedthrough lines that electrically connect the first surface and the second surface of a circuit board; a pair of first signal lines arranged with a gap therebetween on the first surface of the circuit board; a first movable section arranged opposite to the gap; and a first and a second ground patterns arranged on the first surface of the circuit board which sandwich the pair of first signal lines therebetween. The first movable section can switch between being in contact with and being spaced from the pair of first signal lines. The pair of first signal lines are electrically connected to the pair of first feedthrough lines, respectively. The first and second ground patterns are extended close to the pair of first signal lines to form a coplanar line with respect to the pair of first signal lines. Each of the first ground pattern and the second ground pattern is close to and spaced from the first feedthrough line. Here, it is preferred that each of the first ground and the second ground is spaced from the first feedthrough enough not to interfere with the electromagnetic wave generated between the first feedthrough and the first signal line.

The diameter for each of the pair of first feedthrough lines is larger than the width of each first signal line. In this case, it is preferred that the distance between the feedthrough and the ground is spaced from each other such that the impedance is around 50 ohm.

The high-frequency circuit apparatus may further include a second feedthrough line electrically connected to the first surface and the second surface of the circuit board; a second signal line arranged with a gap to one of the first signal lines on the first surface of the circuit board; and a second movable section arranged opposite to the gap. The second signal line is electrically connected to the second feedthrough line. The second movable section can switch between being in contact with and being spaced from the one of the first signal lines and the second signal line independent of the first movable section. The first ground pattern and the second ground pattern are extended close to the second signal line with a gap therebetween to form a coplanar line with respect to the second signal line. Each of the first ground pattern and the second ground pattern is close to and spaced from the second feedthrough line.

The diameter of the second feedthrough line is larger than the width of the second signal line.

In the high-frequency circuit apparatus, an electric signal inputted to one of the pair of first feedthrough lines may be outputted to the other of the pair of first feedthrough lines by contacting the first movable section with the first surface of the circuit board. Meanwhile, an electric signal inputted to the one of the pair of first feedthrough lines may be outputted to the other of the second feedthrough lines by contacting the second movable section with the first surface of the circuit board.

In the high-frequency circuit apparatus, each of the first and the second movable sections may have a bimorph section, a movable contact and a heater. The bimorph section includes a fixed end fixed to the circuit board and a free end spaced from the circuit board and extended from the fixed end that switches between being in contact with the first surface of the circuit board and being spaced from the surface of the circuit board due to being bent by heating. The heater is disposed close to the leading edge of the free end of the bimorph section. When the free end of the bimorph section is in contact with the first surface of the circuit board, the heater heats the movable contact that electrically connects the pair of first or second signal lines, and the bimorph section.

The high-frequency circuit apparatus may further include a pair of third feedthrough lines and a pair of fourth feedthrough lines. The pair of third feedthrough lines spaced from each other on the circuit board that electrically connects the first surface and the second surface of the circuit board, respectively and supplies electrical power to the heater included in the first movable section on the first surface of the circuit board. The fourth feed line spaced from the third feedthrough line on the circuit board that electrically connects between the first surface and the second surface of the circuit board and supplies electric power to the heater included in the second movable section, where, the heater is disposed between the fourth throughfeed line and the third throughfeed line. Moreover, the whole of the high-frequency circuit apparatus may be sealed in one package.

Here, all necessary features of the present invention are not listed in the summary of the invention. The sub-combinations of the features may become the invention.

### BRIEF DESCRIPTION OF THE DRAWINGS

FIG. 1 is a top plan view showing a microswitch 500 according to the present embodiment; and

FIG. 2 is a cross-sectional view showing a state that the microswitch 500 is packaged on an external substrate 600.

### DESCRIPTION OF EXEMPLARY EMBODIMENTS

Hereinafter, the present invention will now be described through preferred embodiments. The embodiments do not limit the invention according to claims and all combinations of the features described in the embodiments are not necessarily essential to means for solving the problems of the invention.

### Embodiment 1

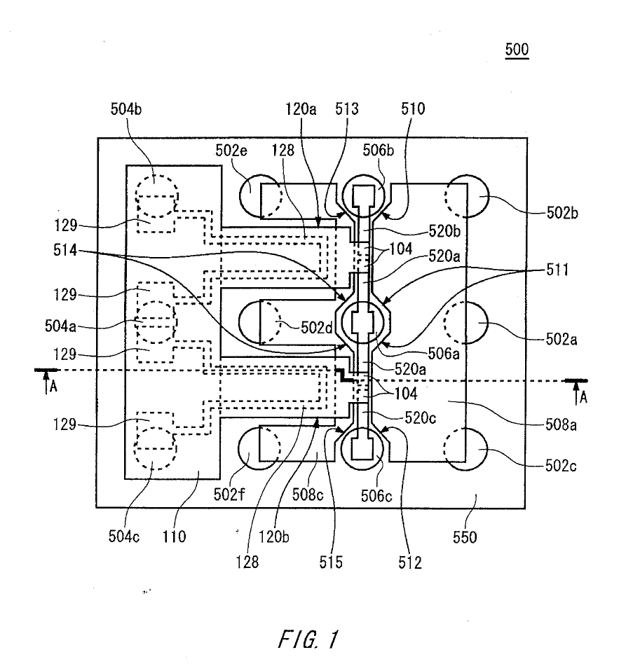

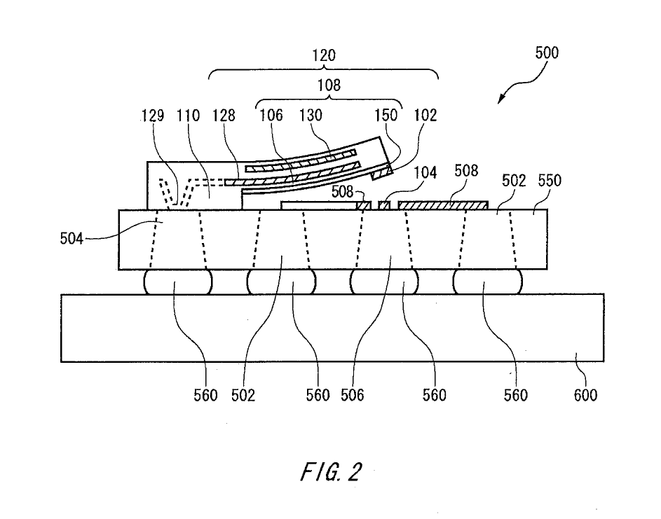

FIG. 1 is a top plan view showing a microswitch 500 according to the present embodiment. FIG. 2 is a cross-sectional view showing a state that the microswitch 500 is packaged on an external substrate 600. FIG. 2 is cut by A-A line shown in FIG. 1. The microswitch 500 is an example of SPDT (Single Pole Double Throw) switch having one input and two outputs. The micro switch 500 includes a circuit board 550, a pair of movable sections 120 and support section 110. The movable section 120 is a switch formed of a cantilever. The support section 110 is fixed to the circuit board 550 and supports one end of the movable section 120. The circuit board 550 is a glass substrate, for example. The circuit board 550 may be a silicon substrate.

The microswitch 500 according to the present embodiment is characterized by switching speedily and accurately the signal path of a high-frequency signal. The horizontal and vertical size of the circuit board 550 may be 4 mm by 5 mm, and the thickness is about 0.3 mm, for example.

The movable section 120 can be in contact with and spaced from the first surface of the circuit board 550. For example, the movable section 120 includes a bimorph section 108 and a heater 128 as actuators. The bimorph section 108 has a fixed end supported by the support section 110 and a free end which is spaced from the circuit board 550 and extended from the free end. The bimorph section 108 is warped upwardly as going from the fixed end to the free end. The free end of the bimorph section 108 is bent toward the circuit board 550 by heating and switches between being in contact with and being spaced from the first surface of the circuit board 550. The bimorph section 108 includes a silicon oxide layer 106, and a metal layer 130 which is formed on the silicon oxide layer 106 and has a thermal expansion coefficient higher than that of the silicon oxide layer 106. The metal layer 130 includes metal such as copper or aluminium.

The heater 128 is a conductor formed by a pattern for efficiently heating the metal layer 130 and the silicon oxide layer 106. For example, the heater 128 is provided between the metal layer 130 and the silicon oxide layer 106 in substantially parallel thereto. In this case, the heater 128 and the metal layer 130 are insulated from each other by covering the circumference of the heater 128 with an insulator such as silicon oxide. The movable section 120 further includes a movable contact 102. The movable contact 102 is provided on the bottom surface (the leading edge) of the bimorph section 108, i.e. the movable contact 102 is provided on a surface opposed to the circuit board 550. Meanwhile, the circuit board 550 includes a fixed contact at a position opposed to the movable contact 102. The bimorph section 108 holds the movable contact 102 spaced from the fixed contact 104 at a certain distance at room temperature. The length of the bimorph section 108 according to the present embodiment is about 600 μm, and the height from the fixed contact 104 at the center of the movable contact 102 is about 50 μm.

A heater electrode 129 is a metal electrode electrically connected to the heater 128. When electric power is supplied to the heater 128 through the heater electrode 129, the metal layer 130 and the silicon oxide layer 106 are heated at approximately the same time. Thereby the metal layer 130 is extended above the silicon oxide 106 so that the bimorph section is deformed in such direction that the amount of warping is reduced. Therefore, the bimorph section 108 causes the movable contact 102 to be in contact with the fixed contact 104. Thereby the movable contact 102 is electrically connected to the fixed contact 104. The movable contact 102 and the fixed contact 104 include metal such as platinum.

The support section 110 is a silicon oxide layer formed on the first surface of the circuit board 550. The support section 110 supports only one end of the bimorph section 108 in the present embodiment. Meanwhile, the support section 110 may support both ends of bimorph section 108 in another embodiment. Additionally, the movable section 120 may have piezoelectric element(s) as an actuator and also may have a static electrode that drives the movable section 120 by electrostatic force.

The circuit board 550 has two movable sections 120a and 120b, and three feedthroughs 506a, 506b and 506c for signal. The feedthroughs 506a, 506b and 506c for signal are spaced from each other and electrically connect between the first surface and the second surface of the circuit board, respectively. Here, the feedthroughs 506a and 506b for signal are an example of the first feedthrough line of the present invention. The feedthrough 506c for signal is an example of the second feedthrough line of the present invention.

On the first surface of the circuit board 550, a pair of first signal line 520a and 520b are formed on a straight line connecting the pair of feedthroughs 506a and 506b for signal. The pair of signal lines 520a and 520b are electrically connected to the pair of feedthroughs 506a and 506b for signal, respectively. The pair of signal lines 520a and 520b are faced to each other with a gap therebetween. The fixed contacts 104 are placed at the leading edges of the pair of first signal lines which are faced to each other, respectively. When the movable section 120a is in contact with the fixed contact 104 for each of the pair of first signal lines 520a and 520b, the feedthrough 506a for signal and the feedthrough 506b for the signal are electrically connected through the first signal lines 520a and 520b, and the fixed contacts 104.

In the same way, on the first surface of the circuit board 550, the first signal line 520a and the second signal line 520c are formed on a straight line connecting the pair of feedthroughs 506a and 506c for signal. The second signal line 520c is electrically connected to the feedthrough 506c for signal. The first signal line 520a and the second signal line 520c are faced to each other with a gap therebetween. The fixed contacts 104 are arranged at the leading edges of the first signal line 520a and the second signal line 520c which are faced to each other, respectively. When the movable section 120b is in contact with the fixed contact 104 for each of the first signal line 520a and the second signal line 520c, the feedthrough 506a for signal and the feedthrough 506c for signal are electrically connected to each other through the first signal line 520a, the second signal line 520c and the fixed contact 104. Here, the feedthrough 506 for signal is connected to an external substrate 600 through a solder ball 560.

By individually switching whether electric power is supplied to each of a pair of feedthroughs 504b for heater, a switching for each of the movable sections 120 between being in contact with the first surface of the circuit board 550 or being spaced from the first surface of the circuit board 550 can be individually and speedily performed. Thereby a switching whether a high-frequency signal inputted to the feedthrough 506a for signal is outputted to each feedthrough 506b for signal can be individually and speedily performed.

According to the above described embodiment, the wire length from the second surface of the circuit board 550 is short in the microswitch 500. Additionally, the movable section 120 of the microswitch 500 is in contact with or spaced from the circuit board 550, so that the line length on the circuit board 550 can be reduced. Moreover, by employing the bimorph section 108 as a microswitch, the switch can be compact as a whole, and thereby the line length on the circuit board 550 can be reduced. The inductance for the whole of switch is reduced because the wire length is short, so that an advantage that an input signal is not attenuated even if the signal is a high-frequency signal. Further, the microswitch 500 can be surface-mounted on the external substrate 600 with the solder ball 560, so that the efficiency of packaging can be improved.

Since the movable section 120 has the bimorph section 180 and the heater 129 as actuators, the movable section 120 can speedily operate by changing to supply electric power to the heater 128. Thereby the response speed of the microswitch 500 can be improved. Additionally, since the movable section 120 has the bimorph section 108 as the driving means, an advantage being capable of reducing the dimension of the movable section 120 can be obtained in comparison with the case that electrostatic attraction is used for the driving means. The circuit board 550 has a pair of feedthroughs 504a and 504b for heater for the movable section 120a, and a pair of feedthroughs for heater 504a and 504c for the movable section 120b. The feedthroughs 504a, 504b and 504c for heater supply electric power to the heater 128 through the heater electrode 129 on the first surface of the circuit board 550. The three feedthroughs for heater 504a, 504b and 504c are spaced from each other on the circuit board 550 and electrically connect between the first surface and the second surface of the circuit board 550, respectively. Each of the feedthroughs 504a and 504b for heater is an example of the second feedthrough line of the present invention. The circuit board 550 can supply electric power to the heater 128 through a short wiring because of having the feedthroughs 504a, 504b and 504c for heater. Therefore, the temperature of the heater 128 is quickly increased at supplying electric power, so that the movable section 120 can be speedily operated. Thereby the response speed of the microswitch 500 can be increased.

Additionally, the circuit board 550 has three reference potential feedthroughs 502, 502b and 502c on one half side of the first signal line 520a. The three potential feedthroughs 502, 502b and 502c are spaced from each other and electrically connect between the first surface and the second surface of the circuit board 550, respectively. The reference potential feedthroughs 502a 502b and 502c constitute the reference potential of the microswitch 500. Each of the reference potential feedthroughs 502a and 502b is an example of first reference potential feedthrough of the present invention. The circuit substrate 550 further includes a ground 508a which has a gap to the signal line 520 and is extended close to the first signal lines 520a and 520b, and the second signal line 520c. The ground 508a is electrically connected to each of the reference potential feedthroughs 502a, 502b and 502c. The ground 508a is an example of the first ground pattern of the present invention.

Moreover, the circuit board 550 includes three reference potential feedthroughs 502b, 502e and 502f on the other half side of the first signal line 520a. The three reference potential feedthroughs 502d, 502e and 502f are spaced from each other and electrically connect between the first surface and the second surface of the circuit board 550, respectively. The reference potential feedthroughs 502d, 502e and 502f constitute the reference potential of the microswitch 500. Each of the reference potential feedthroughs 502d and 502e is an example of the second reference potential feedthrough line of the present invention. The circuit board 550 further include a ground 508c which has a gap to the first signal line 520a and the second signal line 520c on one side of the first signal line 520a, which is opposed to the ground 708 and is extended close to the first signal line 520a and the second signal line 520c. The ground 508c is electrically connected to each of the reference potential feedthroughs 502d, 502e and 502f. The ground 508c is an example of the second ground pattern of the present invention.

Here, the diameter for each of the reference potential feedthrough 502, the feedthrough 504 for heater and the feedthrough 506 for heater is about 0.35 mm. The length for each of the first signal lines 520a and 520b, and the second signal line 520c is about 600 μm. The width for each of them is about 200 μm. Moreover, the size of the gap for each of the fixed contacts 104 for the first signal lines 520a and 502b, and the second signal line 520c is about 50 μm. Further, the distance between the first signal lines 520a and 520b and the second signal line 520c, and the grounds 508a and 508c is set to about 30 μm based on the width of the signal line and the conductivity of the circuit board.

The ground 508a has a slope 511 close to and spaced from the feedthrough 506a for signal. Additionally, the ground 508a has a slope 510 close to and spaced from the feedthrough 506b for signal, and a slope 512 close to and spaced from the feedthrough 506c for signal. In the same way, the ground 508c has slopes 513, 514 and 515 which are close to and spaced from the feedthroughs 506a, 506b and 506c for signal, respectively. In this case, it is preferred that due to the slopes 510, 511, 512, 513, 514 and 515, the ground 508a and 508c are spaced from each other enough not to interfere with the electromagnetic wave radiated from the point at which the feedthroughs 506a, 506b and 506c for signal with a large diameter and the first and the second signal lines 520a, 520b and 520c are coupled. Especially, it is preferred that the more the frequency of the signal applied to the first and the second signal lines 520a, 520b and 520c are high, the more the distance between the grounds 508a and 508c, and the feedthroughs 506a, 506b and 506c for signal are increased. In the present embodiment which employs the signal of tens of GHz, it is preferred that the grounds 508a and 508c are spaced from the feedthroughs 506a, 506b and 506c for signal by about 100 μm. Thereby it is preferred that the impedance is about 50 ohm.

As described above, the microswitch 500 has a coplanar line including the grounds 508a and 508b close to the first signal lines 520a and 520b, and the second signal line 520c. Thereby the inductance of the microswitch can be reduced. Additionally, the slopes 510, 511, 512, 513, 514 and 515 allow to prevent the grounds 508a and 508b from short-circuiting by contacting the feedthroughs 506a, 506b and 506c for signal each of which diameter is larger than that for each of the first signal line 520a and 520b, and the second signal line 520c Further, the slopes 510, 511, 512, 513, 514 and 515 allow to prevent the grounds 508a and 508c from collecting the electromagnetic wave radiated from the portions at which the feedthroughs 506a, 506b and 506c for signal are coupled to the first and second signal lines 520a, 520b and 520c thereby to reduce the power of the signal.

Here, the metal layer 130 may be a precipitation hardened alloy such as titanium copper and berylium copper. Since the precipitation hardened copper alloy such as titanium copper and berylium copper has an excellent stress relaxation property, the bimorph section 108 is not much distorted in operation. Therefore it can provide an advantage that the shape of the bimorph section 108 is not easily changed over time.

The bimorph section 108 further includes a deformation preventing section that covers the surface of the silicon oxide layer 106 and has permeability of moisture and oxygen less than that of the silicon oxide layer 106. The deformation preventing section layer 150 is a silicon nitride film, for example. The silicon nitride can form a film finer than that of silicon oxide and more certainly shield from moisture and oxygen. Alternatively, the deformation preventing section layer 150 may be a silicon oxide film formed with energy higher than the energy for forming the silicon oxide layer 106. The silicon oxide is formed as a film finer by increasing the energy for forming the film, so that it can more certainly shield from moisture and oxide. In this case, the deformation preventing layer 150 can be formed as a film with material the same as that of the silicon oxide layer 106, so the bimorph section 108 can be easily manufactured. As described above, since the bimorph section 108 has the deformation preventing section 150, the silicon oxide layer 106 can be prevented from being expanded by changing over time. Therefore, the shape of the bimorph section 108 can be more accurately maintained.

Hereinafter, an example of manufacturing the movable section 120 will be described. The method of manufacturing the movable section 120 includes a metal layer forming step, an annealing step, a heater forming step, a silicon oxide layer forming step, a deformation preventing layer forming step, a movable contact forming step and a sacrifice layer removing step. Firstly, in the metal layer forming step, metal such as copper or aluminium is spattered at room temperature and deposited on a sacrifice layer including such as silicon oxide to form the metal layer 130.

Next, in the annealing step, the metal layer 130 formed on the sacrifice layer is annealed. An internal stress generated when the metal is spattered and deposited remains in the metal layer 130 formed on the sacrifice layer. Then, the internal stress is relaxed by annealing. The temperature of the annealing should be higher than the temperature for recrystallizing the metal with which the metal layer 130 is formed and the temperature of plasma CVD described later. For example, when copper is used for the material for the metal layer, the temperature for annealing is about 400 degrees C. Meanwhile, when aluminium is used for material for the metal layer 130, the temperature for annealing is about 350 degree C. The appropriate time for annealing is about 15 minutes.

By the annealing, the atoms in the metal layer 130 are recrystallized, so that the lattice defects are decreased. Thereby the internal stress in the metal layer 130 is relaxed, so that one cause for changing the shape of the bimorph section 108 over time can be removed. Additionally, since the internal stress in the metal layer 130 is relaxed in the annealing step, the metal layer 130 can be prevented from being deformed even if the metal layer 130 is placed under the temperature of about 300 degree C. by the plasma CVD in the silicon forming step described later. Therefore, the amount of warping of the bimorph section 108 can be accurately controlled by wattage for depositing the silicon oxide layer 160 by the CVD in the initial stage of manufacturing the bimorph section 108.

Next, firstly an insulating layer is formed on the surface of the metal layer 130 in the heater forming step. The insulating layer is formed by depositing the silicon oxide by the CVD, for example. Then, metal such as copper or gold is spattered at room temperature and deposited to form the heater 128. Next, silicon oxide is deposited on the insulating layer and the heater 128 formed in the heater forming step by the plasma CVD with TEOS (tetraethoxysilane) in the silicon oxide layer forming step. The silicon oxide layer forming step according to the present embodiment forms the silicon oxide layer 160 under the condition that the output of the plasma CVD is adjusted to 130 watt and 300 degree C. Here, it is preferred that a chrome layer is formed on the metal layer 130 and a titanium layer is formed thereon, then, the silicon oxide layer 106 is formed thereon. Thereby the degree of adhesion between the silicon oxide layer 106 and the metal layer 130 can be improved.

Next, the deformation preventing layer 150 is formed by depositing silicon nitride on the silicon oxide layer 106 by the plasma CVD in the deformation preventing layer forming step. Meanwhile, the deforming preventing layer 150 may be formed by depositing silicon oxide by the plasma CVD of which energy is higher than the energy in the silicon oxide layer forming step. When the deformation preventing layer 150 is formed by the silicon oxide, the silicon oxide is deposited while the output of the plasma CVD is adjusted to such as 150 watt. Since the silicon oxide is deposited by the plasma CVD of which energy is higher than the energy in the silicon oxide layer forming step, the silicon oxide of the deformation preventing layer 150 forms a film finer than that of the silicon oxide of the silicon oxide layer 106.

Next, a high corrosion-resistant metal such as gold is spattered and deposited on the surface of the deformation preventing layer 150 and the metal deposited on the region other than the movable contact 102 is removed by etching to form the movable contact 102 in the movable contact forming step. Finally, the sacrifice layer supporting the metal layer 130 is removed by etching in the sacrifice layer removing step. Then, the bimorph section 108 is warped toward the metal layer 130 side in accordance with the internal stress difference between the silicon oxide layer 106 and the metal layer 130. The magnitude of the warping at that time is determined based on the magnitude of the energy of the plasma CVD, i.e. the magnitude of the wattage in the silicon oxide layer forming step. The more the wattage of the plasma CVD is increased, the more the amount of warping of the bimorph section 108 is increased. The appropriate amount of warping of the bimorph section 108 of the present embodiment can be obtained by adjusting the output of the plasma CVD in the silicon oxide layer forming step to about 130 watt as described above. By turning the bimorph section 108 obtained by the above described step upside down, the bimorph section 108 with the posture as shown in FIG. 2 can be obtained.

The deforming preventing layer 150 including silicon nitride can form a film finer than that of the silicon oxide and more certainly shield from moisture and oxygen. Additionally, since the deformation preventing layer 150 formed by depositing the silicon oxide by the plasma CVD of which energy is higher than the energy in the silicon oxide layer forming step has a film finer than that of the silicon oxide of the silicon oxide layer 106, the silicon layer 106 can be shielded from moisture and oxygen. In this case, the deformation preventing layer 150 can form as a film with the material same as that for the silicon oxide layer 106, so that the deformation preventing section 150 can be easily manufactured.

That is, the microswicth 500 has the deformation preventing section 150, so that the silicon oxide layer 106 can be prevented from expanding by changing over time. Thereby the shape of the bimorph section 108 is accurately maintained, so that the contact gap between the fixed contact 104 and the movable contact 102 is stabilized. Therefore, it can provide an advantage that both of the electric power inputted to the heater 128 in order to performing a switching and the response speed of switching can be stabilized. Here, the bimorph device of the present invention may be a micromachine such as a microsensor.

As evidenced by the above description, the present embodiment provides the microswitch 500 of which wire length from the second surface of the circuit board is short, and which can be surface-mounted on the external substrate by the solder balls. In the microswitch 500 of the present embodiment, the line length as a stub can be reduced less than 0.6 mm provided that the diameter of the feedthrough and the land is less than 0.6 mm. Since the microswicth has a short wire length, it can provide an advantage that the inductance for the whole switch is reduced and the signals are not attenuated in the wide band. Especially, the switch can be compact in whole by using the bimorph section 108 as the microswitch, thereby the line length on the circuit can be more reduced. Moreover, the microswitch can be surface-mounted on the external substrate, so that the packaging effect is improved. Here, the maicroswitch 500 may further include a resistor to form an attenuator.

While the present invention has been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

What is claimed is:

1. A high-frequency circuit apparatus comprising:
a pair of first feedthrough line arranged on a circuit board;
a pair of first signal lines arranged with a gap therebetween on the first surface of the circuit board;
a first movable section arranged opposite to the gap; and
a first and a second ground patterns arranged on both side of the pair of first signal lines; wherein
the first movable section can be in contact with and spaced from the pair of first signal lines,
the pair of first signal lines are electrically connected to the pair of first feedthrough lines, respectively,
the first and second ground patterns are extended close to the pair of first signal lines to form a coplanar line with respect to the pair of first signal lines, and
each of the first ground pattern and the second ground pattern is close to and spaced from the first feedthrough line.

2. The high-frequency circuit apparatus as set forth in claim 1, wherein the diameter for each of the pair of first feedthrough lines is larger than the width of each first signal line.

3. The high-frequency circuit apparatus as set forth in claim 2 further comprising
A second feedthrough line electrically connected to the first surface and the second surface of the circuit board;
a second signal line arranged with a gap to one of the first signal lines on the first surface of the circuit board; and
a second movable section arranged opposite to the gap, wherein
the second signal line is electrically connected to the second feedthrough line,
the second movable section can switch between being in contact with and being spaced from the one of the first signal lines and the second signal line independent of the first movable section,
the first ground pattern and the second ground pattern are extended close to the second signal line with a gap therebetween to form a coplanar line with respect to the second signal line, and each of the first ground pattern and the second ground pattern is close to and spaced from the second feedthrough line.

4. The high-frequency circuit apparatus as set forth in claim 3, wherein the diameter of the second feedthrough line is larger than the width of the second signal line.

5. The high-frequency circuit apparatus as set forth in claim 4, wherein
an electric signal inputted to one of the pair of first feedthrough lines is outputted to the other of the pair of first feedthrough lines by contacting the first movable section with the first surface of the circuit board, and
an electric signal inputted to the one of the pair of first feedthrough lines is outputted to the other of the second feedthrough lines by contacting the second movable section with the first surface of the circuit board.

6. The high frequency circuit apparatus as set forth in claim 5, wherein
each of the first movable section and the second movable section including:
a bimorph section having a fixed end fixed to the circuit board and a free end extended from the fixed end; and
a movable contact arranged close to the leading edge of the free end of the bimorph section that electrically connects the pair of first signal lines or the pair of second signal lines with each other when the free end of the bimorph section is in contact with the first surface of the circuit board; and
a heater that heats the bimorph section.

7. The high frequency circuit apparatus as set forth in claim 6 further comprising:
a pair of third feedthrough lines that supply electric power to the heater included in the first movable section on the first surface of the circuit board; and
a forth feedthrough line that supplies electric power to the heater included in the second movable section, the heater arranged between one of the third feedthrough lines and the fourth feedthrough line.

8. The high-frequency circuit apparatus as set forth in claim 7, wherein the whole of the high-frequency circuit apparatus is sealed in one package.

9. A method of manufacturing a bimorph device, comprising:
forming a metal layer on a sacrifice layer;
annealing the metal layer formed in the metal layer forming step; and
forming a silicon oxide layer on the metal layer annealed in the annealing step.

10. The method of manufacturing a bimorph device as set forth in claim 1, wherein the metal layer forming step forms the metal layer with precipitation hardened metallic compound.

11. The method of manufacturing a bimorph device as set forth in claim 1, wherein the annealing step anneals the metal layer with a temperature higher than a temperature for recrystallizing the metal forming the metal layer.

12. The method of manufacturing a bimorph device as set forth in claim 1, wherein the annealing step anneals the metal layer with a temperature higher than a temperature in the silicon oxide layer forming step.

13. The method of manufacturing a bimorph device as set forth in claim 1, wherein the silicon oxide layer forming step forms the silicon oxide layer by a plasma CVD method.

14. The method of manufacturing a bimorph device as set forth in claim 9 further comprising forming a deformation preventing layer on the surface of the silicon oxide.

15. The method of manufacturing a bimorph device as set forth in claim 14, wherein the deformation preventing layer is formed by depositing silicon nitride in the deformation preventing layer forming step.

16. The method of manufacturing a bimorph device as set forth in claim 14, wherein
the silicon oxide layer is formed by depositing silicon oxide by the plasma CVD in the silicon oxide layer forming step,
the deformation preventing layer is formed in the deformation preventing layer forming step by depositing silicon oxide by the plasma CVD with energy higher than the energy in the silicon oxide layer forming step.
